(19) United States
(12) Patent Application Publication
(10) Pub. No.: US 2005/0188494 A1
(43) Pub. Date: Sep. 1, 2005

(54) Self-propelling cleaner

(75) Inventor: Hiroyuki Takenaka, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/051,176

(22) Filed: Feb. 4, 2005

(30) Foreign Application Priority Data
Feb. 4, 2004 (JP) JP2004-028519

(51) Int. Cl. A47L 9/28

(52) U.S. Cl. 15/319; 15/340.1

(57) ABSTRACT

When receiving an area value of a cleaning area and its shape that is a rectangle or a circle, a self-propelling cleaner 1 decides on a cleaning area having the input shape (rectangle or circle) and size and decides to employ, as a movement route to be taken in cleaning the cleaning area, a spiral movement route having the center of the cleaning area as a start point. Therefore, whether the cleaning area is rectangular or circular, the cleaning area can be cleaned without leaving no non-cleaned regions and almost no regions outside the cleaning area are cleaned. That is, the cleaning area can be cleaned efficiently.

### BACKGROUND OF THE INVENTION

1. Field of the Invention

The present invention relates to a self-propelling cleaner that cleans a floor or the like by sucking dust thereon with its main body self-propelled.

2. Description of the Related Art

Self-propelling cleaners are known that, upon reception of an input for setting a cleaning area, clean the cleaning area while moving around there are put in practical use. Self-propelling cleaners suck dust into a dust room provided inside the main body through a nozzle provided in the bottom surface of the main body. As in the case of known non-self-propelling cleaners, the sucking force for sucking duct is produced by rotating a suction fan. Self-propelling cleaners clean a set cleaning area while moving around there with sucking force kept produced, that is, with the suction fan kept rotating.

There is disclosed in JP-A-9-269824 a self-propelling cleaner in which when a user inputs longitudinal and lateral lengths of a cleaning area, a rectangular area having the input longitudinal and lateral lengths and having the current position of the main body as one corner is set as a cleaning area. This self-propelling cleaner cleans every nook and cranny in the entire cleaning area as it zigzags in such a manner that it reciprocates in the longitudinal direction of the rectangular cleaning area and its position is shifted in the lateral direction by a prescribed value every time its moving direction is changed.

There is disclosed in JP-A-2002-032123 a self-propelling cleaner in which a user specifies four corners of a cleaning area to be set by manipulating a remote controller that utilizes light emission. This self-propelling cleaner sets, as a cleaning area, a rectangular closed area formed by connecting the specified four corners and cleans the closed area while moving around there.

### SUMMARY OF THE INVENTION

However, the conventional self-propelling cleaners have a problem that a complicated input manipulation is necessary for setting of a cleaning area, that is, users cannot manipulate them with ease. Further, since the conventional self-propelling cleaners clean a cleaning area while zigzagging there, if a circular cleaning area is set non-cleaned regions occur or, conversely, regions outside the cleaning area are also cleaned. More specifically, non-cleaned regions occur if a self-propelling cleaner zigzags in a rectangle that is inscribed in the circular cleaning area, and regions outside the cleaning area are also cleaned if a self-propelling cleaner zigzags in a rectangle that is circumscribed about the circular cleaning area. This results in a problem that the conventional self-propelling cleaners cannot clean a circular cleaning area efficiently.

One of objects of the present invention is to provide a self-propelling cleaner in which a manipulation that is necessary for setting of a cleaning area is simplified and hence a user can manipulate it with greater ease.

Another object of the invention is to provide a self-propelling cleaner that allows setting of a circular cleaning area and can clean a set circular cleaning area efficiently by moving spirally in the circular cleaning area.

According to a first aspect of the invention, there is provided a self-propelling cleaner including: a main body; an autonomous propelling unit that autonomously propels the main body; a suction unit that rotates a suction fan to collect dust within the main body from a nozzle formed at the main body; a cleaning area determining information receiving unit that receives an input of cleaning area determining information to be used for determining a cleaning area; a cleaning area determining unit that determines a cleaning area on the basis of the cleaning area determining information received by the cleaning area determining information receiving unit, and that determines a movement route of the main body in the cleaning area; a cleaning unit that operates the suction unit to collect dust from the nozzle while controlling the autonomous propelling unit to propel the main body along the movement route determined by the cleaning area determining unit; and a movement distance detecting unit that detects a movement distance of the main body moved by the autonomous propelling unit, wherein the cleaning area determining information receiving unit receives a planer dimension of the cleaning area, wherein the cleaning area determining unit employs, as the cleaning area, a rectangular or circular area having the planer dimension received by the cleaning area determining information receiving unit and having a position of the main body as the center of the cleaning area, and determines the moving route to be a spiral route having the center of the cleaning area as a start point, wherein the cleaning area determining information receiving unit receives a shape type indicating whether the cleaning area is rectangular or circular in shape in addition to an area value of the cleaning area, wherein the cleaning area determining unit determines a shape of the cleaning area on the basis of the shape type received by the cleaning area determining information receiving unit, and wherein the cleaning unit calculates a start-to-end distance from the start point to an end point along the movement route in the cleaning area determined by the cleaning area determining unit, and finishes cleaning of the cleaning area when the movement distance of the main body that has been detected by the movement distance detecting unit since a start of the cleaning of the cleaning area has reached the start-to-end distance.

According to a second aspect of the invention, there is provided a self-propelling cleaner including: a main body; an autonomous propelling unit that autonomously propels the main body; a suction unit that rotates a suction fan to collect dust within the main body from a nozzle formed at the main body; a cleaning area determining information receiving unit that receives an input of cleaning area determining information to be used for determining a cleaning area; a cleaning area determining unit that determines a cleaning area on the basis of the cleaning area determining information received by the cleaning area determining information receiving unit, and that determines a movement route of the main body in the cleaning are; and a cleaning unit that operates the suction unit to collect dust from the nozzle while controlling the autonomous propelling unit to propel the main body along the movement route determined by the cleaning area determining unit, wherein the cleaning area determining information receiving unit receives a planer dimension of the cleaning area, and wherein the cleaning area determining unit employs, as the cleaning area, a rectangular or circular area having the planer dimension received by the cleaning area determining information receiving unit and having a position of the main body as the center of the cleaning area, and determines the moving route to be a spiral route having the center of the cleaning area as a start point.

### BRIEF DESCRIPTION OF THE DRAWINGS

The above objects and advantages of the present invention will become more apparent by describing a preferred exemplary embodiment thereof in detail with reference to the accompanying drawings, wherein:

FIG. 1 is a block diagram showing the configuration of the main part of a self-propelling cleaner according to an embodiment of the present invention;

FIGS. 2A and 2B are schematic diagrams showing the structure of the self-propelling cleaner according to the embodiment;

FIG. 3 is a flowchart showing the operation of the self-propelling cleaner 1 according to the embodiment;

FIGS. 4A and 4B show a movement route for a rectangular cleaning area;

FIGS. 5A and 5B show a movement route for a circular cleaning area; and

FIGS. 6A and 6B show respective movement routes for rectangular and elliptical cleaning areas.

### DETAILED DESCRIPTION OF THE PREFERRED EMBODIMENTS

A self-propelling cleaner according to an embodiment of the present invention will be hereinafter described.

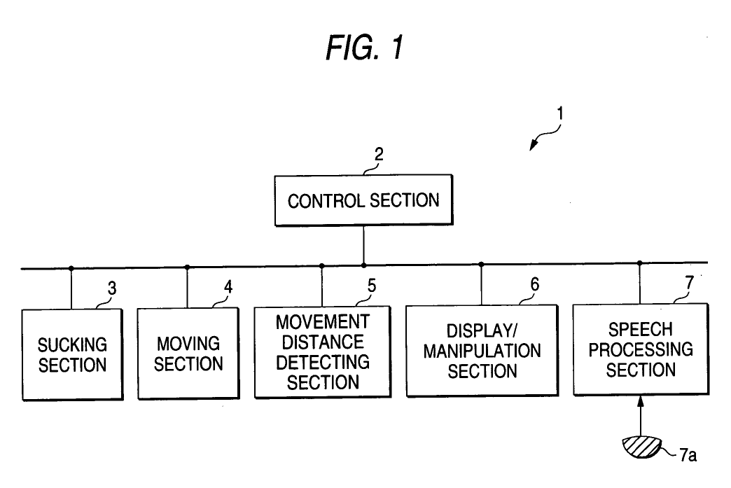

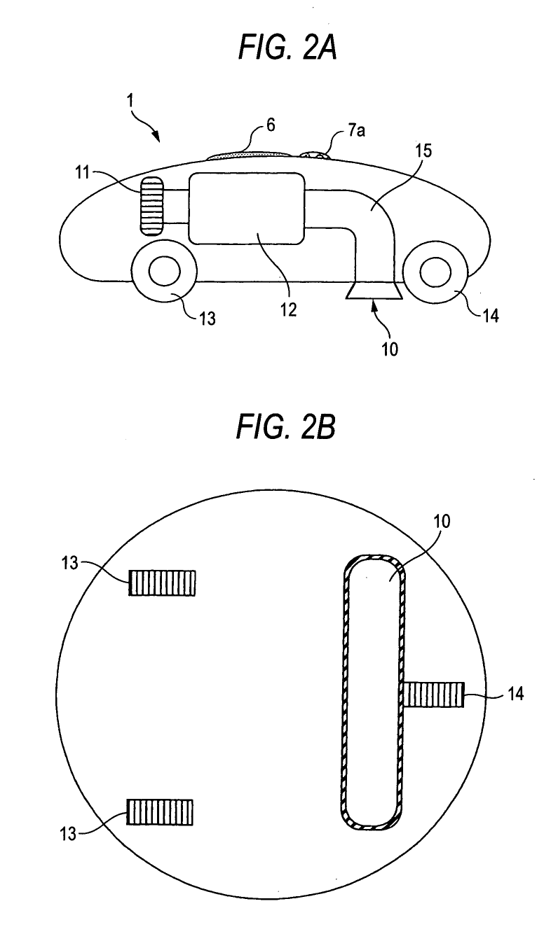

FIG. 1 is a block diagram showing the configuration of the main part of the self-propelling cleaner according to the embodiment of the invention. FIGS. 2A and 2B are schematic diagrams showing the structure of the self-propelling cleaner. FIG. 2A is a side sectional view and FIG. 2B is a bottom view. The self-propelling cleaner 1 is equipped with a control section 2 for controlling the operation of the main body, a sucking section 3 for sucking dust into a dust room 12 provided inside the main body through a nozzle 10 by rotating a suction fan 11, a moving section 4 for autonomously propelling the main body, a movement distance detecting section 5 for detecting the movement distance of the main body that has been moved by the moving section 4, a display/manipulation section 5 for displaying the status of the main body and receiving a manipulation input to the main body, and a speech processing section 7 for processing a voice that is picked up by a microphone 7a.

As shown in FIGS. 2A and 2B, the self-propelling cleaner 1 is substantially formed in hemispherical shape. Dust that is sucked through the nozzle 10 by the sucking section 3's rotating the suction fan 11 is collected into a dust pack (not shown) attached to the duct room 12 via a pipe 15 that connects the nozzle 10 and the dust room 12. As shown in FIG. 2B, the nozzle 10 is an opening that is located at a relatively forward position in the bottom surface of the main body and extends in the width direction of the main body. The main body is equipped with a door that is located over the dust room 12 and is opened and closed in replacing the dust pack. A user replaces the dust pack when a large amount of dust has been collected therein. A pair of driving wheels 13 that are located on both sides so as to be opposed to each other is provided in the rear of the main body, and a follower wheel 14 is located close to the front of the main body approximately at the center in the right-left direction. The moving section 4 controls the rotation speeds of the two driving wheels 13 individually and can thereby control the moving direction of the main body, that is, can cause its right turn, left turn, advancement, retreat, etc. The moving section 4 controls the moving direction of the main body, in other words, the rotation speeds of the respective driving wheels 13, in accordance with a movement instruction from the control section 2.

The follower wheel 14 is a wheel that is provided for stability of movement of the main body. Although in this embodiment the one follower wheel 14 is located close to the front of the main body approximately at the center in the right-left direction, two follower wheels may be located on both sides so as to be opposed to each other like the driving wheels 13. The movement distance detecting section 5 may be such as to detect the movement distance of the main body on the basis of the measurement value of an acceleration sensor (not shown) provided in the main body or to detect the rotation speed of the driving wheels 13 or the follower wheel 14 and detect the movement distance on the basis of the detected rotation speed. The movement distance detecting section 5 may even be configured in other form.

The display/manipulation section 6 may be equipped with a receiving section for receiving a control code to the main body that is transmitted from a remote controller (not shown) by radio or infrared light. This allows the user to remotely control the self-propelling cleaner 1. The speech processing section 7 processes a voice that is picked up by the microphone 7a, and supplies the control section 2 with an operation instruction of the voice to the main body. In the self-propelling cleaner 1 according to this embodiment, a cleaning area can be specified by inputting an area value and a shape (rectangle or circle) of an intended cleaning area. A cleaning area can be specified by a key manipulation on the display/manipulation section 6, a manipulation on the remote controller, a voice input to the speech processing section 7, or in a like manner.

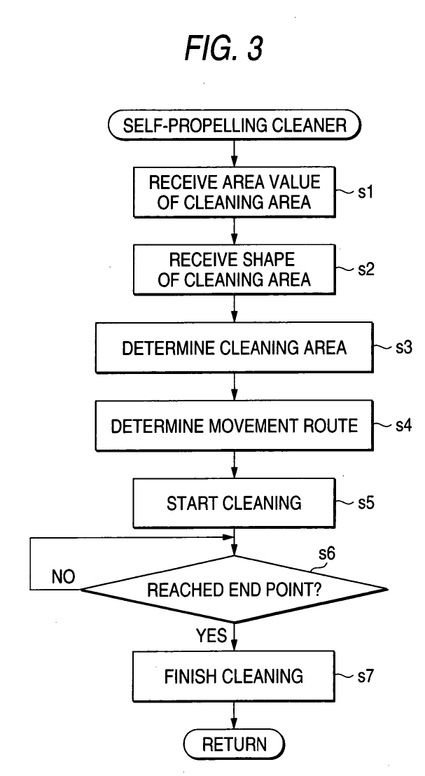

Next, the operation of the self-propelling cleaner 1 according to the embodiment will be described. FIG. 3 is a flowchart showing the operation of the self-propelling cleaner 1 according to the embodiment. The self-propelling cleaner 1 receives an input of an area value and a size of an intended cleaning area (s1 and s2) Although this flowchart is such that a shape of a cleaning area is received after reception of its area value, a shape of a cleaning area may be received first. At these steps, the user inputs an area value and a shape (rectangle or circle) of a cleaning area by a key manipulation on the display/manipulation section 6, a manipulation on the remote controller, a voice input to the speech processing section 7. The area value is input by using a ten-key or by voice in square meters, for example, and the shape is input by selecting a rectangle or a circle by using a selection key or by voice.

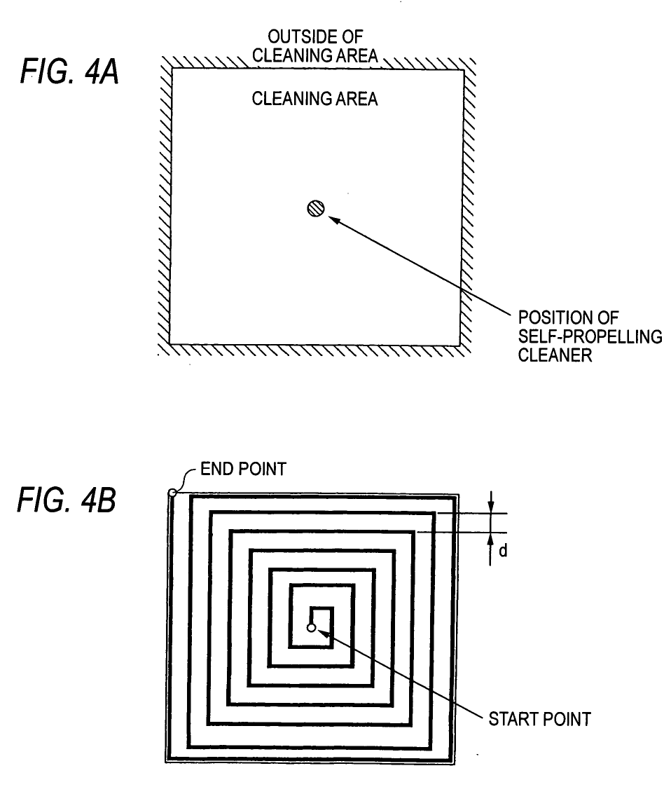

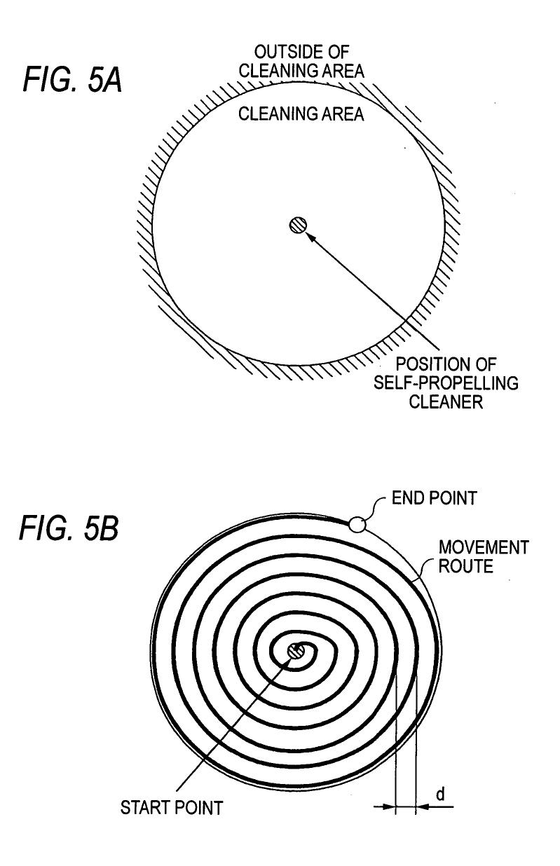

The self-propelling cleaner 1 determines a cleaning area on the basis of the area value and shape of the input cleaning area that were received at steps s1 and s2 and a current position of the vacuum cleaner (s3). More specifically, if the shape of the input cleaning area is a rectangle, as shown in FIG. 4A, the self-propelling cleaner 1 employs, as a cleaning area, a square having the current position of the self-propelling cleaner 1 as the center and having the input area value. On the other hand, if the shape of the input cleaning area is a circle, as shown in FIG. 5A, the self-propelling cleaner 1 employs, as a cleaning area, a regular circle having the current position of the self-propelling cleaner 1 as the center and having the input area value.

After determining the cleaning area at step s3, the self-propelling cleaner 1 determines a movement route of the main body to be taken in cleaning the cleaning area (s4). More specifically, if the cleaning area that was determined at step s3 is a rectangle as shown in FIG. 4A, the self-propelling cleaner 1 decides on a spiral movement route having, as a cleaning start point, the center of the cleaning area, that is, the current position of the main body of the self-propelling cleaner 1 (see FIG. 4B). If the cleaning area that was determined at step s3 is a circle as shown in FIG. 5A, the self-propelling cleaner 1 decides on a spiral movement route having, as a cleaning start point, the center of the cleaning area (see FIG. 5B). As is apparent from FIGS. 4B and 5B, the movement route that was determined at step s4 is a rectangular spiral if the cleaning area is a rectangle, and it is a circular spiral if cleaning area is a circle.

An end point shown in each of FIGS. 4B and 5B is a point where the self-propelling cleaner 1 stops cleaning the cleaning area.

After determining the movement route at step s4, the self-propelling cleaner 1 starts cleaning the cleaning area (s5). At step s5, the sucking section 3 starts rotating the suction fan 11 to produce sucking force for sucking dust through the nozzle 10 and the moving section 3 starts causing the main body to move from the start point to the end point along the route that was determined at step s4. Since the self-propelling cleaner 1 is located at the start point at the start of cleaning, it is not necessary for the self-propelling cleaner 1 to move to the start point immediately before the start of cleaning. After the cleaning was started at step s5, the self-propelling cleaner 1 detects, on the basis of the movement distance of the main body that is detected by the movement distance detecting section 5, where the main body is located on the movement route that was determined at step s4. The moving section 4 switches the movement direction of the main body (causes a right turn, a left turn, or the like) so that the main body moves along the movement route that was determined at step s4. When reaching the end point, the self-propelling cleaner 1 stops the movement of the main body and finishes the cleaning by stopping the rotation of the suction fan 11 (s6 and s7) More specifically, the self-propelling cleaner 1 judges that the main body has reached the end point and finishes the cleaning when the movement distance of the main body that is detected by the movement distance detecting section 5 has reached the distance from the start point to the end point of the spiral movement route that was decided at step s4.

The self-propelling cleaner 1 determines the movement route at step s4 so that the distance d between adjoining portions of the movement route is a little shorter than the lateral width of the nozzle 10. Therefore, when the self-propelling cleaner 1 moves from the start point to the end point along the movement route that was determined at step s4, regions that are not opposed to the nozzle 10 do not occur in the cleaning area and almost no regions that are opposed to the nozzle 10 occur outside the cleaning region, irrespective of the shape of the cleaning area. In other words, the self-propelling cleaner 1 can clean every nook and cranny in the cleaning area and cleans almost no regions outside the cleaning area whether the shape of the cleaning area is a rectangle or a circle. That is, the self-propelling cleaner 1 can clean the cleaning area efficiently. Further, since the switching control on the movement direction of the main body and the cleaning completion judgment are performed on the basis of the movement distance of the main body, a specified area of a space having no nearby objects such as walls can be cleaned without leaving no non-cleaned regions.

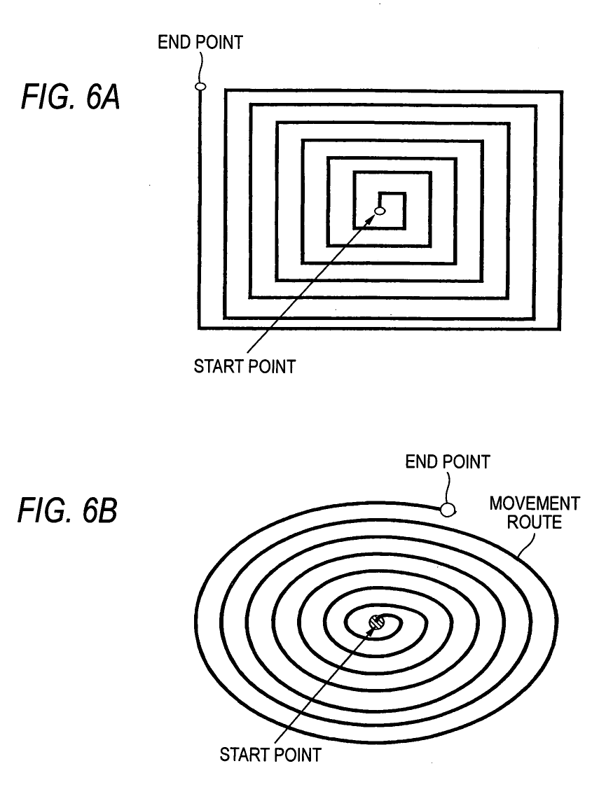

Although the self-propelling cleaner 1 according to the embodiment is configured such that only a square or a regular circle can be set as a cleaning area, it is possible to enable setting of a rectangular or elliptical cleaning area. This can be done by causing a user to input an aspect ratio (e.g., 1:2) in addition to an area value and a shape in setting a cleaning area. FIG. 6A shows a movement route in the case where a rectangular cleaning area is set. FIG. 6B shows a movement route in the case where an elliptical cleaning area is set. Also in theses cases, the cleaning area is cleaned by moving the main body along a spiral movement route whose start point is set at the center of the cleaning area, whereby the cleaning area can be cleaned efficiently.

To solve the above problems, self-propelling cleaners according to the invention have the following configurations:

(1) A self-propelling cleaner includes: a main body; an autonomous propelling unit that autonomously propels the main body; a suction unit that rotates a suction fan to collect dust within the main body from a nozzle formed at the main body; a cleaning area determining information receiving unit that receives an input of cleaning area determining information to be used for determining a cleaning area; a cleaning area determining unit that determines a cleaning area on the basis of the cleaning area determining information received by the cleaning area determining information receiving unit, and that determines a movement route of the main body in the cleaning are; and a cleaning unit that operates the suction unit to collect dust from the nozzle while controlling the autonomous propelling unit to propel the main body along the movement route determined by the cleaning area determining unit, wherein the cleaning area determining information receiving unit receives a planer dimension of the cleaning area, and wherein the cleaning area determining unit employs, as the cleaning area, a rectangular or circular area having the planer dimension received by the cleaning area determining information receiving unit and having a position of the main body as the center of the cleaning area, and determines the moving route to be a spiral route having the center of the cleaning area as a start point.

In this configuration, the cleaning area determining information receiving unit receives an area value of a cleaning area, and the cleaning area determining unit decides to employ, as the cleaning area, a rectangular or circular area having the area value received this time and having the position of the main body as the center. Therefore, a user can set a cleaning area merely by inputting a planer dimension. A manipulation necessary for setting of a cleaning area is simplified; that is, the user can manipulate the vacuum cleaner with greater ease.

Further, the cleaning area determining unit decides to employ, as the movement route of the main body, a spiral route having the center of the cleaning area determined this time as a start point (of cleaning). The cleaning area is cleaned by moving the main body along the thus-determined movement route. Since it is decided to employ, as the movement route to be taken in cleaning, a spiral route having the center of the cleaning area as the center, the thus-set cleaning area can be cleaned without leaving no non-cleaned regions while almost no regions outside the cleaning area are cleaned whether the cleaning area is rectangular or circular. Therefore, even a circular cleaning area can be cleaned efficiently.

(2) In the self-propelling cleaner, the cleaning area determining information receiving unit receives a shape type indicating whether the cleaning area is rectangular or circular in shape in addition to an area value of the cleaning area, and wherein the cleaning area determining unit determines a shape of the cleaning area on the basis of the shape type received by the cleaning area determining information receiving unit.

With this configuration, the user can determine, in accordance with a current situation, whether to set a rectangular or circular cleaning area. This allows the user to manipulate the vacuum cleaner with even greater ease.

(3) In the self-propelling cleaner, there is further provided a movement distance detecting unit that detects a movement distance of the main body moved by the autonomous propelling unit, wherein the cleaning unit calculates a start-to-end distance from the start point to an end point along the movement route in the cleaning area determined by the cleaning area determining unit, and finishes cleaning of the cleaning area when the movement distance of the main body that has been detected by the movement distance detecting unit since a start of the cleaning of the cleaning area has reached the start-to-end distance.

With this configuration, the cleaning is finished when the movement distance of the main body has reached the distance from the start point to the end point (of the cleaning) of the determined movement route.

As described above, according to the embodiment, a user can set a cleaning area merely by inputting a planer dimension. A manipulation necessary for setting of a cleaning area is simplified; that is, the user can manipulate the vacuum cleaner with greater ease.

Further, since it is decided to employ, as the movement route to be taken in cleaning, a spiral route having the center of the cleaning area as the center, the thus-set cleaning area can be cleaned efficiently whether the cleaning area is rectangular or circular.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

1. A self-propelling cleaner comprising:
a main body;
an autonomous propelling unit that autonomously propels the main body;
a suction unit that rotates a suction fan to collect dust within the main body from a nozzle formed at the main body;
a cleaning area determining information receiving unit that receives an input of cleaning area determining information to be used for determining a cleaning area;
a cleaning area determining unit that determines a cleaning area on the basis of the cleaning area determining information received by the cleaning area determining information receiving unit, and that determines a movement route of the main body in the cleaning are;
a cleaning unit that operates the suction unit to collect dust from the nozzle while controlling the autonomous propelling unit to propel the main body along the movement route determined by the cleaning area determining unit; and
a movement distance detecting unit that detects a movement distance of the main body moved by the autonomous propelling unit,
wherein the cleaning area determining information receiving unit receives a planer dimension of the cleaning area,
wherein the cleaning area determining unit employs, as the cleaning area, a rectangular or circular area having the planer dimension received by the cleaning area determining information receiving unit and having a position of the main body as the center of the cleaning area, and determines the moving route to be a spiral route having the center of the cleaning area as a start point,
wherein the cleaning area determining information receiving unit receives a shape type indicating whether the cleaning area is rectangular or circular in shape in addition to an area value of the cleaning area,
wherein the cleaning area determining unit determines a shape of the cleaning area on the basis of the shape type received by the cleaning area determining information receiving unit, and
wherein the cleaning unit calculates a start-to-end distance from the start point to an end point along the movement route in the cleaning area determined by the cleaning area determining unit, and finishes cleaning of the cleaning area when the movement distance of the main body that has been detected by the movement distance detecting unit since a start of the cleaning of the cleaning area has reached the start-to-end distance.

2. A self-propelling cleaner comprising:
a main body;
an autonomous propelling unit that autonomously propels the main body;
a suction unit that rotates a suction fan to collect dust within the main body from a nozzle formed at the main body;
a cleaning area determining information receiving unit that receives an input of cleaning area determining information to be used for determining a cleaning area;
a cleaning area determining unit that determines a cleaning area on the basis of the cleaning area determining information received by the cleaning area determining information receiving unit, and that determines a movement route of the main body in the cleaning are; and
a cleaning unit that operates the suction unit to collect dust from the nozzle while controlling the autonomous propelling unit to propel the main body along the movement route determined by the cleaning area determining unit,
wherein the cleaning area determining information receiving unit receives a planer dimension of the cleaning area, and
wherein the cleaning area determining unit employs, as the cleaning area, a rectangular or circular area having the planer dimension received by the cleaning area determining information receiving unit and having a position of the main body as the center of the cleaning area, and determines the moving route to be a spiral route having the center of the cleaning area as a start point.

3. The self-propelling cleaner according to claim 2, wherein the planer dimension includes at least one of a size of the cleaning area and a shape of the cleaning area.

4. The self-propelling cleaner according to claim 2, wherein the cleaning area determining information receiving unit receives a shape type indicating whether the cleaning area is rectangular or circular in shape in addition to an area value of the cleaning area, and
wherein the cleaning area determining unit determines a shape of the cleaning area on the basis of the shape type received by the cleaning area determining information receiving unit.

5. The self-propelling cleaner according to claim 2, further comprising a movement distance detecting unit that detects a movement distance of the main body moved by the autonomous propelling unit,
wherein the cleaning unit calculates a start-to-end distance from the start point to an end point along the movement route in the cleaning area determined by the cleaning area determining unit, and finishes cleaning of the cleaning area when the movement distance of the main body that has been detected by the movement distance detecting unit since a start of the cleaning of the cleaning area has reached the start-to-end distance.
